(19) United States
(12) Patent Application Publication
(10) Pub. No.: US 2025/0027419 A1
(43) Pub. Date: Jan. 23, 2025

(54) METHOD OF MANUFACTURING A COMPONENT OF A GAS TURBINE ENGINE

(71) Applicant: ROLLS-ROYCE plc, London (GB)

(72) Inventors: James R. KINGSLEY-ROWE, Bath (GB); Christopher NEALE, Bristol (GB); Stefan J. WAGNER, Derby (GB)

(73) Assignee: ROLLS-ROYCE plc, London (GB)

(21) Appl. No.: 18/771,137

(22) Filed: Jul. 12, 2024

(30) Foreign Application Priority Data
Jul. 19, 2023 (GB) 2311067.9

(51) Int. Cl. F01D 5/28; F01D 5/18

(52) U.S. Cl. CPC F01D 5/288; F01D 5/18; F05D 2220/32; F05D 2230/31; F05D 2240/30; F05D 2260/231

(57) ABSTRACT

There is provided a method of manufacturing a component of a gas turbine engine, comprising: providing a precursor component having at least one internal cooling passage configured to receive a flow of cooling air therethrough; estimating a predicted temperature profile for the component based on one or more operating parameters of the gas turbine engine, the predicted temperature profile indicating a predicted operating temperature of at least one gas-washed surface of the component; determining a thermal barrier coating (TBC) configuration for the component based on the predicted temperature profile, comprising setting a TBC thickness to be below a threshold thickness in a region of the at least one gas-washed surface of the component based on the predicted operating temperature of the at least one gas-washed surface of the component exceeding a threshold temperature; and applying a TBC to the precursor component according to the TBC configuration.

### CROSS-REFERENCE TO RELATED APPLICATIONS

This disclosure claims the benefit of UK Patent Application No. GB 2311067.9, filed on 19 Jul. 2023, which is hereby incorporated herein in its entirety.

### BACKGROUND

### Technical Field

The present disclosure relates to a method of manufacturing a component of a gas turbine engine and a system for manufacturing a component of a gas turbine engine.

### Description of Prior Art

Components of a gas turbine engine, such as a turbine blade, operate under extreme temperatures and harsh environmental conditions. For this reason, Thermal Barrier Coatings (TBCs) are applied to these components in order to protect them from such high temperatures. A TBC acts as a protective layer having a low thermal conductivity and therefore reduces heat transfer rates from the high temperature environment to the component. These components also have an internal cooling system configured to direct a flow of cooling air through the component. The TBC and the internal cooling system act together to limit the increase of the temperature of the component during operation of the gas turbine engine.

TBCs are generally applied using line-of-sight coating or deposition processes, such as electron-beam physical vapour deposition (EB-PVD), in which the component is moved relative to a source of coating material to ensure that all desired surfaces are coated with the TBC. Due to the complex shapes of gas turbine engine components, it can be difficult to achieve the desired TBC thickness in certain areas of the component with line-of-sight deposition processes. For example, some areas may have a higher TBC thickness than required, creating an excessive amount of insulation on the component surface. This can create excessive component surface temperatures, which can be detrimental to the life of the component. These issues are typically addressed by increasing the capacity of the cooling system to increase the level of cooling air delivered to the component. However, this can reduce the efficiency of the gas turbine engine.

It is therefore desired to develop an improved method of manufacturing a component of a gas turbine engine which addresses at least some of the aforementioned issues.

### SUMMARY

According to a first aspect of the present disclosure, there is provided a method of manufacturing a component of a gas turbine engine, comprising: providing a precursor component having at least one internal cooling passage configured to receive a flow of cooling air therethrough; estimating a predicted temperature profile for the component based on one or more operating parameters of the gas turbine engine, the predicted temperature profile indicating a predicted operating temperature of at least one gas-washed surface of the component; determining a thermal barrier coating (TBC) configuration for the component based on the predicted temperature profile, comprising setting a TBC thickness to be below a threshold thickness in a region of the at least one gas-washed surface of the component based on the predicted operating temperature of the at least one gas-washed surface of the component exceeding a threshold temperature; and applying a TBC to the precursor component according to the TBC configuration.

The one or more operating parameters may comprise at least one parameter relating to a temperature of operation of the gas turbine engine, a temperature of the component during operation of the gas turbine engine, an air pressure during operation of the gas turbine engine, a location of operation of the gas turbine engine and/or a geometry of the component.

The one or more operating parameters may further comprise a cooling airflow capacity of the component defined by the at least one internal cooling passage.

The at least one gas-washed surface of the component may be formed by an external surface of the precursor component.

Estimating the predicted temperature profile may further comprise estimating a predicted TBC thickness for the component based on an application of a baseline TBC level to the precursor component, wherein the at least one gas-washed surface is formed by the baseline TBC; and determining the predicted operating temperature of the at least one gas-washed surface based on the one or more operating parameters of the gas turbine engine.

Determining the TBC configuration may comprise adjusting a baseline TBC thickness as defined by the baseline TBC level.

The threshold temperature may be based on the operating conditions of the gas turbine engine, a type of the component, a geometry of the component, a material of the component, a material of the TBC, a material of a bond coat applied to the precursor component, and/or a cooling airflow capacity of the component.

Applying the TBC to the precursor component according to the TBC configuration may comprise using a line-of-sight coating process.

Applying the TBC to the precursor component may comprise using at least one mask positioned in a line-of-sight direction between a coating source and the precursor component to inhibit coating to an external surface of the precursor component.

Applying the TBC to the precursor component may comprise applying a TBC having an intermediate thickness to the precursor component using the line-of-sight coating process to form an intermediate component; and removing TBC material from the intermediate component to form a component having a TBC thickness according to the TBC configuration.

Removing TBC material may comprise using a polishing, grinding, or cutting process.

Removing TBC material may comprise using laser ablation, laser cutting, plasma cutting, ultrasonic machining, electrical discharge machining, and/or electro-chemical machining.

According to a second aspect of the present disclosure, there is provided a system for manufacturing a component of a gas turbine engine, comprising: a coating apparatus configured to apply a thermal barrier coating (TBC) to a precursor component, the precursor component at least one internal cooling passage configured to receive a flow of cooling air therethrough; and processing circuitry coupled to the coating apparatus and configured to execute instructions comprising: estimating a predicted temperature profile for the component based on one or more operating parameters of the gas turbine engine, the predicted temperature profile indicating a predicted operating temperature of at least one gas-washed surface of the component; and determining a TBC configuration for the component based on the predicted temperature profile, comprising setting a TBC thickness to be below a threshold thickness in a region of the at least one gas-washed surface of the component based on the predicted operating temperature of the at least one gas-washed surface of the component exceeding a threshold temperature; wherein the coating apparatus is configured to apply a TBC to the precursor component according to the TBC configuration.

The one or more operating parameters may comprise at least one parameter relating to a temperature of operation of the gas turbine engine, a temperature of the component during operation of the gas turbine engine, an air pressure during operation of the gas turbine engine, a location of operation of the gas turbine engine and/or a geometry of the component.

The one or more operating parameters may further comprise a cooling airflow capacity of the component defined by the at least one internal cooling passage.

The at least one gas-washed surface of the component may be formed by an external surface of the precursor component.

Estimating the predicted temperature profile may further comprise: estimating a predicted TBC thickness for the component based on an application of a baseline TBC level to the precursor component, wherein the at least one gas-washed surface is formed by the baseline TBC; and determining the predicted operating temperature of the at least one gas-washed surface based on the one or more operating parameters of the gas turbine engine.

Determining the TBC configuration may comprise adjusting a baseline TBC thickness as defined by the baseline TBC level.

The threshold temperature may be based on the operating conditions of the gas turbine engine, a type of the component, a geometry of the component, a material of the component, a material of the TBC, a material of a bond coat applied to the precursor component, and/or a cooling airflow capacity of the component.

The coating apparatus may be a line-of-sight coating apparatus.

The system may further comprise at least one mask configured to inhibit coating to the precursor component; wherein applying the TBC to the precursor component may comprise positioning the at least one mask in a line-of-sight direction between a coating source and the precursor component to inhibit coating to an external surface of the precursor component.

Applying the TBC to the precursor component may comprise applying a TBC having an intermediate thickness to the precursor component using the line-of-sight coating apparatus to form an intermediate component; and removing TBC material from the intermediate component to form a component having a TBC thickness according to the TBC configuration.

Removing TBC material may comprise using a polishing, grinding, or cutting process.

Removing TBC material may comprise using laser ablation, laser cutting, plasma cutting, ultrasonic machining, electrical discharge machining, and/or electro-chemical machining.

The skilled person will appreciate that except where mutually exclusive, a feature described in relation to any one of the above aspects may be applied mutatis mutandis to any other aspect. Furthermore, except where mutually exclusive, any feature described herein may be applied to any aspect and/or combined with any other feature described herein.

### DESCRIPTION OF THE DRAWINGS

Embodiments will now be described by way of example only, with reference to the Figures, in which:

FIG. 1 is a sectional side view of a gas turbine engine;

FIG. 2A is a sectional view through a known component of a gas turbine engine having a thermal barrier coating (TBC) applied thereto;

FIG. 2B is a detailed view of a trailing edge region of the component of FIG. 2A;

FIG. 3 is a first example system for manufacturing a component of a gas turbine engine according to the present disclosure;

FIG. 4 is a second example system for manufacturing a component of a gas turbine engine according to the present disclosure;

FIG. 5A shows a schematic view of an example mask module according to the present disclosure;

FIG. 5B shows a first perspective view of an example mask module according to the present disclosure;

FIG. 5C shows a second perspective view of an example mask module according to the present disclosure; and

FIG. 6 is a flow diagram showing a method of manufacturing a component of a gas turbine engine according to the present disclosure.

### DETAILED DESCRIPTION

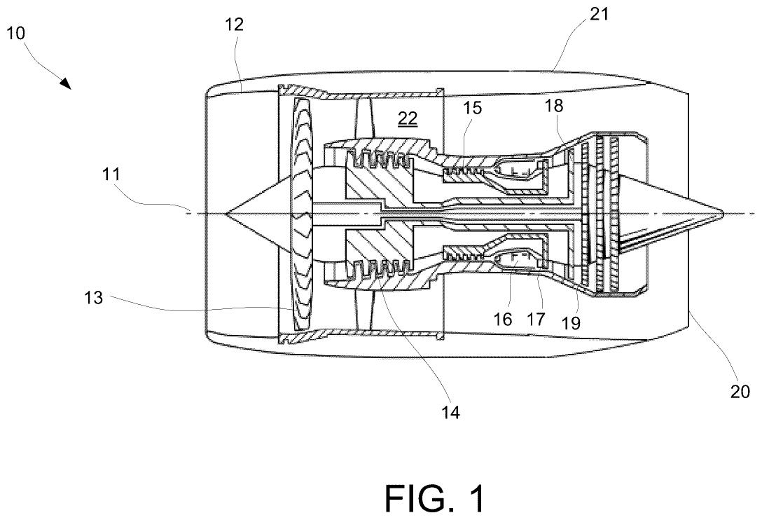

With reference to FIG. 1, a gas turbine engine is generally indicated at 10, having a principal and rotational axis 11. The engine 10 comprises, in axial flow series, an air intake 12, a propulsive fan 13, an intermediate pressure compressor 14, a high-pressure compressor 15, combustion equipment 16, a high-pressure turbine 17, an intermediate pressure turbine 18, a low-pressure turbine 19 and an exhaust nozzle 20. A nacelle 21 generally surrounds the engine 10 and defines both the intake 12 and the exhaust nozzle 20.

The gas turbine engine 10 works in the conventional manner so that air entering the intake 12 is accelerated by the fan 13 to produce two air flows: a first air flow into the intermediate pressure compressor 14 and a second air flow which passes through a bypass duct 22 to provide propulsive thrust. The intermediate pressure compressor 14 compresses the air flow directed into it before delivering that air to the high pressure compressor 15 where further compression takes place.

The compressed air exhausted from the high-pressure compressor 15 is directed into the combustion equipment 16 where it is mixed with fuel and the mixture combusted. The resultant hot combustion products then expand through, and thereby drive the high, intermediate and low-pressure turbines 17, 18, 19 before being exhausted through the nozzle 20 to provide additional propulsive thrust. The high 17, intermediate 18 and low 19 pressure turbines drive respectively the high pressure compressor 15, intermediate pressure compressor 14 and fan 13, each by suitable interconnecting shaft.

Other gas turbine engines to which the present disclosure may be applied may have alternative configurations. By way of example such engines may have an alternative number of interconnecting shafts (e.g. two) and/or an alternative number of compressors and/or turbines. Further the engine may comprise a gearbox provided in the drive train from a turbine to a compressor and/or fan.

Components of a gas turbine engine, such as a turbine blade or parts of the combustor are subject to very high temperatures during operation of the gas turbine engine. Such components are typically coated with a Thermal Barrier Coating (TBC). A TBC is formed from a material with a low thermal conductivity as compared to the relatively high thermal conductivity of the component, which is typically formed from a metallic material. The material of the TBC is typically a ceramic material, such as yttria-stabilised zirconia (YSZ). The purpose of the TBC is to form a thermally insulating layer on the component to protect the component from the high temperatures.

The TBC is typically applied onto the component using a line-of-sight coating method. A line-of-sight coating method is defined as a process in which the component is placed in a chamber, atoms of the TBC coating material are vaporised from a solid material or ingot, and the atoms subsequently travel through the chamber and embed themselves onto the component which is positioned in their path of travel. Examples of line-of-sight coating methods include Electron Beam Physical Vapour Deposition (EB-PVD), Physical Vapour Deposition (PVD), Air Plasma Spray (APS), High Velocity Oxygen Fuel (HVOF), Electrostatic spray-assisted vapour deposition (ESAVD), and Direct Vapour Deposition.

Prior to applying the TBC material to the component, a bond coat will typically first be applied to the surface of the component. The purpose of the bond coat is to protect the metallic component from oxidation and corrosion and to enable the TBC to adhere to the component. The bond coat may be made of NiCrAlY or NiCoCrAlY alloy, or an Ni or Pt aluminide, or from platinum, or from other suitable materials.

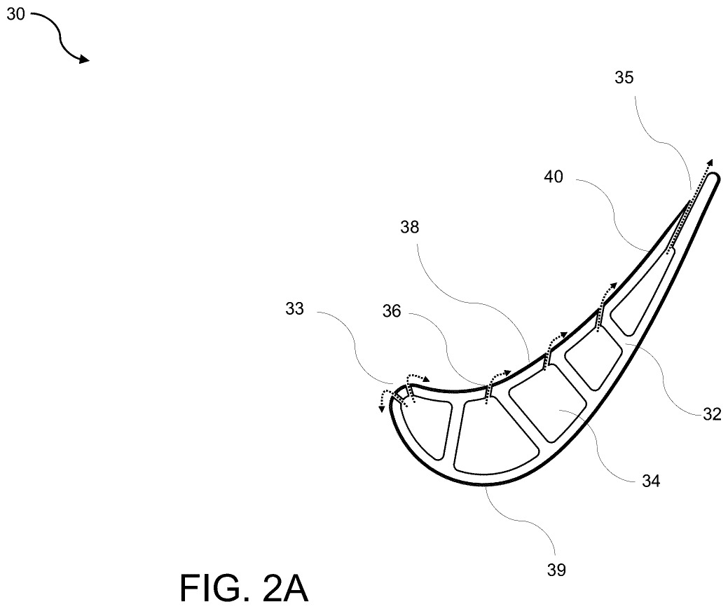

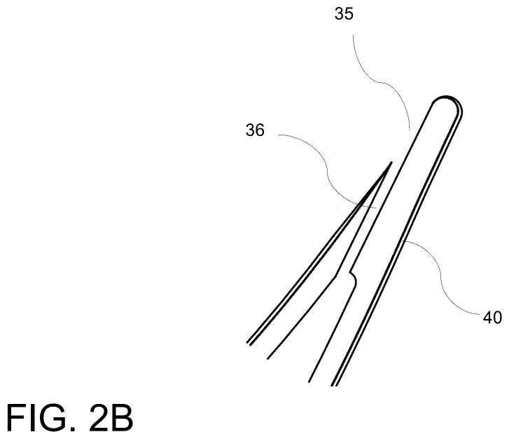

FIG. 2A shows a cross-section through an example of a conventional gas turbine component which is coated with a TBC. The component is a turbine blade 30. The component 30 has an aerofoil shape, having a pressure surface 38 and a suction surface 39. The component 30 is formed from a metallic material. The component 30 has a cooling system which is configured to deliver a cooling airflow to the component 30 in use. The cooling system is made up of one or more internal cooling passages 34 and one or more film cooling holes 36. The internal cooling passages 34 enable cooling airflow to pass through the component 30. The film cooling holes 36 enable cooling airflow to pass out of the internal cooling passages 34 and over the outer surface of the component 30. The outer surface of the component 30 is coated with a TBC 40. The TBC 40 is applied in a substantially uniform manner onto the outer surface of the component 30, such that the TBC 40 has a consistent thickness around the component 30. TBC 40 is generally not applied in cooling passages or in film cooling holes to avoid blocking the cooling airflow. FIG. 2B shows a close-up view of a trailing edge region 35 of the component 30. TBC 40 is not applied in the trailing edge region 35 of the component 30, so as not to block air flowing out of the film cooling hole 36 or insulate the trailing edge 35 from the cooling airflow.

In this application, reference will be made to “gas-washed surfaces” of a gas turbine engine component. It will be understood that the term “gas-washed surfaces” mean those surfaces of the component over which a working gas flows during operation of the gas turbine engine. In this instance, it will be understood that the term “working gas” refers to the gas produced by combustion in the gas turbine engine.

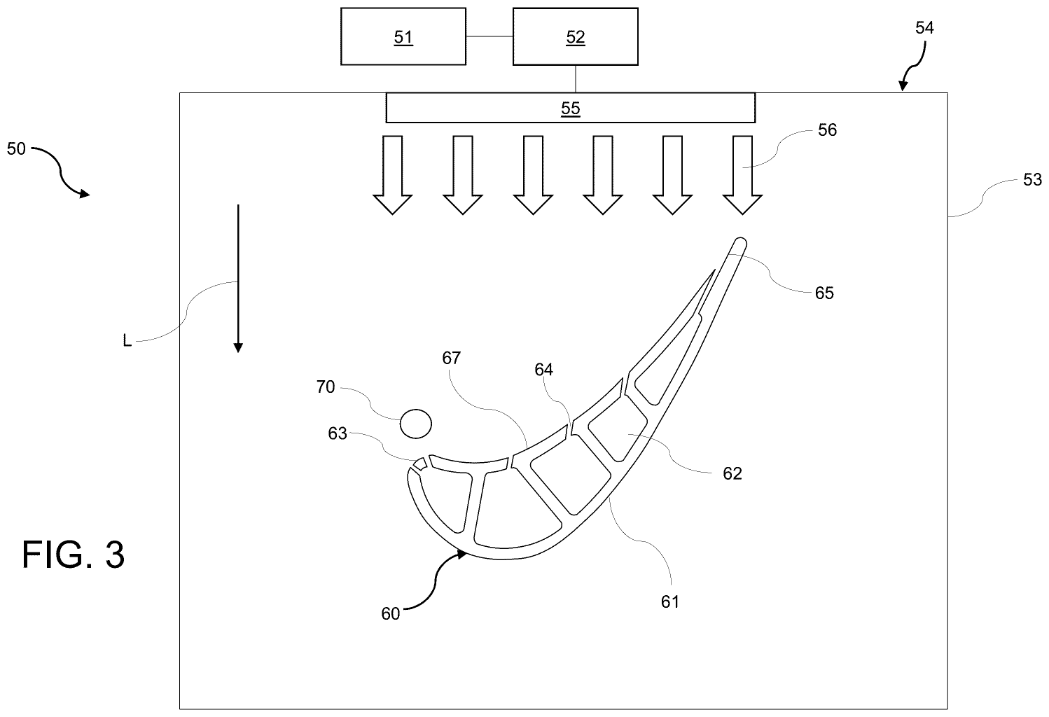

FIG. 3 shows a first example system 50 for manufacturing a component of a gas turbine engine according to the present disclosure. The system 50 comprises a processor 51, a controller 52, and a coating apparatus 54. The coating apparatus 54 is a line-of-sight coating apparatus.

A precursor component 60 of a gas turbine engine is provided. FIG. 3 shows a cross-section through the precursor component 60. The precursor component 60 is a component to which a TBC has not yet been applied. The precursor component 60 is a metallic component. The precursor component 60 may comprise the metallic component only or the metallic component which has been coated with a bond coat. The precursor component 60 is a turbine blade. However, in other examples, the precursor component may be any component of a gas turbine engine to which a TBC is to be applied.

The precursor component 60 comprises an aerofoil shape, having a suction surface 61 and a pressure surface 67. The precursor component 60 also comprises a leading edge 63 and a trailing edge 65. The precursor component 60 comprises a cooling system, having one or more internal cooling passages 62 and one or more film cooling holes 64. The film cooling holes 64 extend from the internal cooling passages 62 to an outer surface (e.g., the pressure surface 67) of the precursor component 60. During operation of the gas turbine engine, cooling airflow flows through the internal cooling passages 62 and out of the component via the film cooling holes 64.

One or more operating parameters of the gas turbine engine are first received by the processor 51. The operating parameters include information relating to the conditions experienced by the component during operation of the gas turbine engine. For example, the operating parameters may relate to a temperature of operation of the gas turbine engine, a temperature of the component during operation of the gas turbine engine, air pressure during operation of the gas turbine engine, a location of operation of the gas turbine engine, and/or the geometry of the component. The operating parameters also include information relating to the cooling airflow capacity of the component, for example the capacity of cooling airflow that can be provided by the cooling system of the component. The cooling capacity is dependent on the at least one internal cooling passage of the component, for example based on the number and structure of the internal cooling passages and the film cooling holes.

The processor 51 is configured to estimate a predicted temperature profile for the component based on the one or more operating parameters. The predicted temperature profile provides an indication of the operating temperature distribution of at least one gas-washed surface of the component during operation of the gas turbine engine. For example, the predicted temperature profile may indicate the maximum, minimum, and average temperatures of at least one gas-washed surface of the component during operation of the gas turbine engine. The processor 51 is configured to estimate the predicted temperature profile based on any suitable correlation between the operating parameters and the predicted temperature values. For example, the processor 51 may refer to a temperature model to estimate the predicted temperature profile based on the one or more operating parameters. The temperature may be an artificial intelligence model, for example a linear regression model, a deep neural network or a decision tree. The temperature model may be trained using experimental data or historical temperature data. For example, the temperature model may form a digital twin. The temperature model may be updated based on updated real-life temperature data and operating data and developments or changes in the hardware of the gas turbine engine. Alternatively, the processor 51 may refer to a simulation which is configured to estimate the predicted temperature profile using one or more mathematical models. In further examples, the processor 51 may refer to a look-up table or database containing predetermined correlations. In the table or database, the one or more operating parameters may correspond to predetermined predicted temperature profiles for the component. These predetermined predicted temperature profiles may be determined from experimental data or from best practice calculations. The processor 51 can look up the one or more operating parameters in the table to find the most appropriate predicted temperature profile for the component. The table or database may be set or updated, for example based on updated best practice calculations or to reflect changes to the hardware of the gas turbine engine and/or the structure and geometry of the component.

The predicted temperature profile of the component can be based on no TBC being applied to the component and/or with a TBC being applied to the component. When the predicted temperature profile is based on a TBC being applied to the component, the processor 51 may be configured to refer to a TBC model which predicts the coverage of TBC on the component based on a baseline level of TBC being applied to the component. A baseline level of TBC may correspond to a level of TBC that is applied to achieve a standard or conventional uniform TBC thickness level on the component. The TBC model may use parameters relating to the baseline level of TBC and the geometry of the precursor component to predict the coverage of TBC in a simulated line-of-sight coating process. The coverage of TBC can be different from a theoretical or desired TBC thickness level due to various factors of the line-of-sight coating process, such as the geometry of the component, the geometry of the coating chamber, the presence and position of other components in the coating chamber, the position of the component in the coating chamber etc.

If the predicted temperature profile is based on no TBC being applied to the component, the predicted operating temperature of the at least one gas-washed surface of the component is the predicted operating temperature of at least one uncoated surface of the component, i.e., a surface of the precursor component 60. If the predicted temperature profile is based on a TBC being applied to the component, the predicted operating temperature of the at least one gas-washed surface of the component is the predicted operating temperature of at least one uncoated surface of the component and/or at least one surface of the component having TBC applied to it.

The processor 51 is configured to determine a TBC configuration for the component based on the predicted temperature profile. The processor 51 is configured to determine whether a predicted operating temperature of one or more gas-washed surfaces of the component exceeds a threshold temperature. The threshold temperature may be set based on the operating conditions of the gas turbine engine, the type and geometry of the component, the material of the component, the material of the TBC, the material of the bond coat, and/or the cooling capacity provided for the component. If a predicted operating temperature of one or more gas-washed surfaces of the component exceeds the threshold temperature, the processor 51 is configured to set a TBC thickness of the gas-washed surface to be below a threshold thickness level. The processor 51 may also be configured to determine that the TBC thickness of the gas-washed surface is a specific thickness value which is below the threshold thickness level. In examples, the processor 51 may determine that no TBC (zero TBC thickness) should be applied on one or more gas-washed surfaces of the component based on the predicted temperature profile. The threshold thickness level may be lower than the TBC thickness defined by the baseline TBC level.

Determining the TBC configuration may involve determining a specific TBC thickness value for each of the gas-washed surfaces of the component. Where a baseline TBC level was used to determine the predicted temperature profile, the processor 51 may be configured to determine the TBC configuration by determining any adjustments to be made to a baseline TBC thickness defined by the baseline TBC level to achieve the determined TBC thickness for the at least one gas-washed surface.

For example, the processor 51 may determine that a gas-washed surface adjacent to the leading edge 63 of the component experiences a higher temperature during operation of the gas turbine engine than other gas-washed surfaces of the component. Accordingly, the processor 51 may determine that this gas-washed surface requires a lower TBC thickness than the other gas-washed surfaces of the component 60.

The processor 51 is therefore configured to determine which areas of the gas-washed surfaces of the component experience the highest operating temperatures and reduce the TBC thickness or completely eliminate the TBC at these areas. The processor 51 may be configured to iteratively determine the TBC configuration. For example, the processor 51 may be configured to determine a first iteration of the TBC configuration, as described above. The processor 51 may then be configured to receive one or more manufacturing process parameters which indicate the capabilities or limitations of the manufacturing process which is to be used to apply the TBC to the precursor component. The processor 51 may then determine one or more subsequent iterations of the TBC configuration based on the first iteration and the one or more more manufacturing process parameters. For example, the first iteration of the TBC configuration may be adjusted or adapted based on the one or more more manufacturing process parameters. This can enable an optimal TBC configuration to be determined such that it can be achieved by the desired manufacturing process or coating apparatus.

The processor 51 is in communication with the controller 52. The controller 52 is configured to receive the determined TBC configuration from the processor 51. The determined TBC configuration may be provided as a TBC thickness target for one or more surfaces of the component. The controller 52 is configured to transmit instructions to the coating apparatus 54 to apply a TBC to the precursor component 60 according to the determined TBC configuration. The controller 52 is configured to control one or more manufacturing parameters of the coating apparatus 54 to enable the determined TBC configuration to be achieved. The coating apparatus 54 may be any coating apparatus configured to apply a TBC coating using a line-of-sight coating method to a component. For example, the line-of-sight coating method may be one of Electron Beam Physical Vapour Deposition (EB-PVD), Physical Vapour Deposition (PVD), Air Plasma Spray (APS), High Velocity Oxygen Fuel (HVOF), Electrostatic spray-assisted vapour deposition (ESAVD), and Direct Vapour Deposition. The coating apparatus 54 comprises a coating chamber 53 in which the precursor component 60 is positioned for coating. The coating chamber 53 may be a vacuum chamber. The coating apparatus 54 comprises a coating material source 55 which forms the material of the TBC. The coating apparatus 54 is configured to generate a vapour 56 of the coating material source 55. The vapour 56 is configured to travel towards the precursor component 60 in a line-of-sight direction L and adhere to its outer surface to form the TBC. The precursor component 60 may be rotated and otherwise moved during this process to coat each surface of the precursor component 60 according to the thicknesses defined by the determined TBC configuration.

The coating apparatus 54 may include one or more masks 70 which are configured to be positioned in the line-of-sight direction L between the coating material source 55 and the precursor component 60 to inhibit coating to an external surface of the precursor component 60. For instance, a mask 70 is configured to be positioned in the line-of-sight direction L of the coating material vapour 56 to inhibit the amount of TBC applied to one or more surfaces of the precursor component 60. The mask 70 is positioned in front of the precursor component 60 in the line-of-sight direction L of the coating material vapour 56. The mask 70 is positioned in front of the leading edge 63 of the precursor component 60. The mask 70 is spaced apart from the leading edge 63. In this position, the mask 70 is configured to block a portion of the coating material vapour 56 as it travels towards the precursor component 60, which reduces the amount of coating material vapour 56 which reaches and adheres to the leading edge 63 of the precursor component 60. This causes the TBC thickness in the leading edge 63 region to be reduced compared to the TBC thickness in the other regions of the component. Accordingly, masks which are spaced apart from the precursor component 60 in this manner can be used to reduce the TBC thickness in specific regions of the component compared to other regions, in order to achieve the TBC thickness defined by the determined TBC configuration.

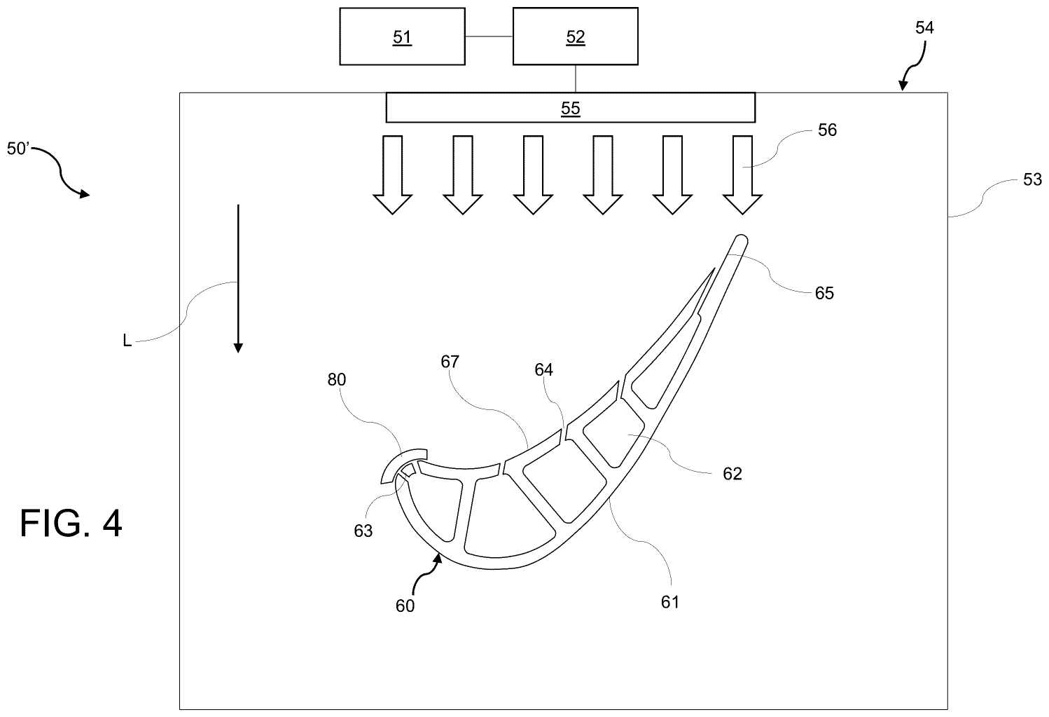

FIG. 4 shows a second example system 50′ for manufacturing a component of a gas turbine engine according to the present disclosure. The second example system 50′ is substantially similar to the first example 50, with like reference numerals denoting like features. The second example system 50′ differs with respect to the arrangement of the masks.

The coating apparatus 54 comprises a mask 80. The mask 80 is positioned in the line-of-sight direction L of the coating material vapour 56 to inhibit the amount of TBC applied to one or more surfaces of the precursor component 60. The mask 80 is positioned in front of the precursor component 60 in the line-of-sight direction L of the coating material vapour 56. The mask 80 is positioned in front of the leading edge 63 of the precursor component 60. The mask 80 is positioned close to the leading edge 63, such that only a negligible gap is present between the mask 80 and the leading edge 63. In this position, the mask 80 is configured to cover the leading edge 63 in a manner which blocks substantially any of the coating material vapour 56 from reaching and adhering to the leading edge 63. This causes the TBC in the leading edge 63 region to have substantially zero thickness. Accordingly, masks which are spaced apart from the precursor component 60 in this manner can be used to substantially eliminate TBC in specific regions of the component, in order to achieve the TBC thickness defined by the determined TBC configuration.

The gap between the mask and the precursor component in the line-of-sight direction L can be varied to control the amount of TBC material which reaches and adheres to the precursor component 60. Smaller gaps between the mask and the precursor component result in lower TBC thickness than for larger gaps. Masks can be formed in any suitable shape to enable the desired TBC thickness to be achieved in any given region of the precursor component 60. The shape of a mask can also be designed based on the position of the precursor component within the coating chamber and the presence and position of other components in the coating chamber. Multiple masks can also be used simultaneously to inhibit the amount of coating material applied to multiple surfaces of the precursor component 60.

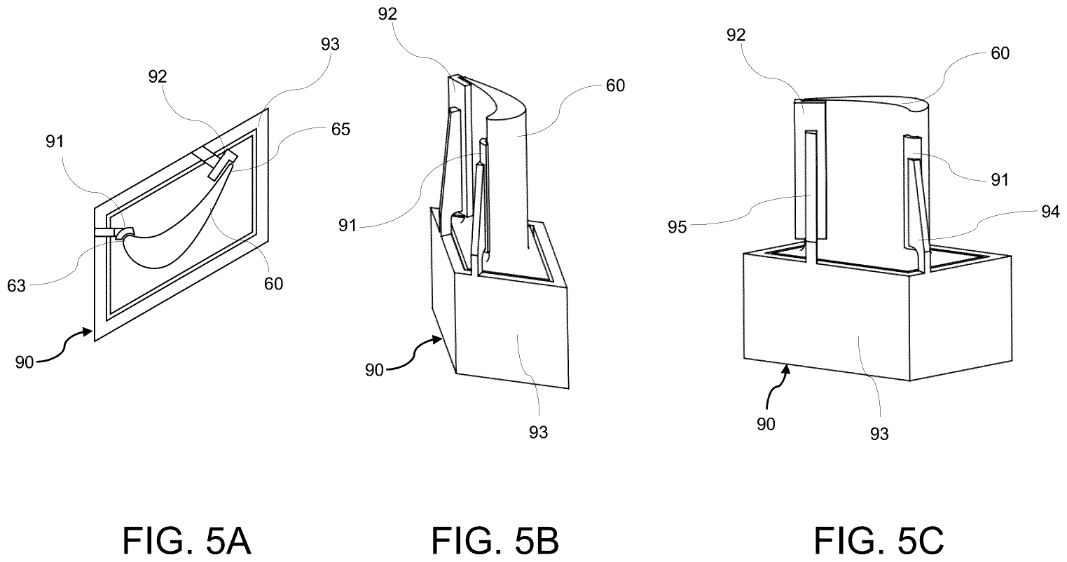

FIGS. 5A to 5C show an example mask module 90 which can be used in a coating apparatus 54 when applying a TBC to the precursor component 60. FIG. 5A shows a schematic view of the mask module 90, FIG. 5B is a first perspective view of the mask module 90, and FIG. 5C is a second perspective view of the mask module 90. The mask module 90 comprises a component support portion 93, a first mask 91, and a second mask 92. The first mask 91 is attached to the component support portion 93 via a first support member 94 and the second mask 92 is attached to the component support portion 93 via a second support member 95. The precursor component 60 is mounted to the component support portion 93. The first mask 91 is positioned adjacent to the leading edge 63 of the precursor component 60 and the second mask 92 is positioned adjacent to the trailing edge 65 of the precursor component 60. The first mask 91 is configured to reduce the line-of-sight of the coating material to the leading edge 63, thereby resulting in a relatively low TBC thickness in this area. The second mask 92 is configured to reduce the line-of-sight of the coating material to the trailing edge 65, thereby resulting a relatively low TBC thickness in this area. In other examples, there may be any number of masks in the mask module. Each mask may be formed in any suitable shape to enable the desired TBC thickness to be achieved in any given region of the precursor component 60. The shape of the support members 94, 95 may be any suitable shape to retain the respective masks in the desired position with respect to the precursor component 60 during the coating process. The mask module 90 can be mounted at suitable positions and orientations within the coating chamber 54 so as to position and orient the precursor component 60 in the required manner to achieve the desired TBC thickness.

Instead of using masks to vary the TBC thickness on different areas of the precursor component 60 as in the examples described above, in other examples, material can be removed from a coated component to achieve a component which has a TBC thickness according to the determined TBC configuration. In such examples, after the TBC configuration has been determined, the controller 52 may instruct the coating apparatus to apply a TBC to the precursor component having a generally uniform thickness which is greater than a maximum thickness defined by the determined TBC profile. This uniform thickness can be referred to as an intermediate TBC thickness. Once this intermediate TBC thickness has been applied to the precursor component, an intermediate component is formed. Subsequently a material removal technique can be used to remove TBC material from selected areas of the intermediate component in order to achieve the desired TBC thickness across the component according to the determined TBC configuration. The material removal technique can be a polishing, grinding, or cutting process. The material removal technique can be one of laser ablation, laser cutting, plasma cutting, ultrasonic machining, electrical discharge machining, and electro-chemical machining, or any other suitable method used to remove TBC coatings.

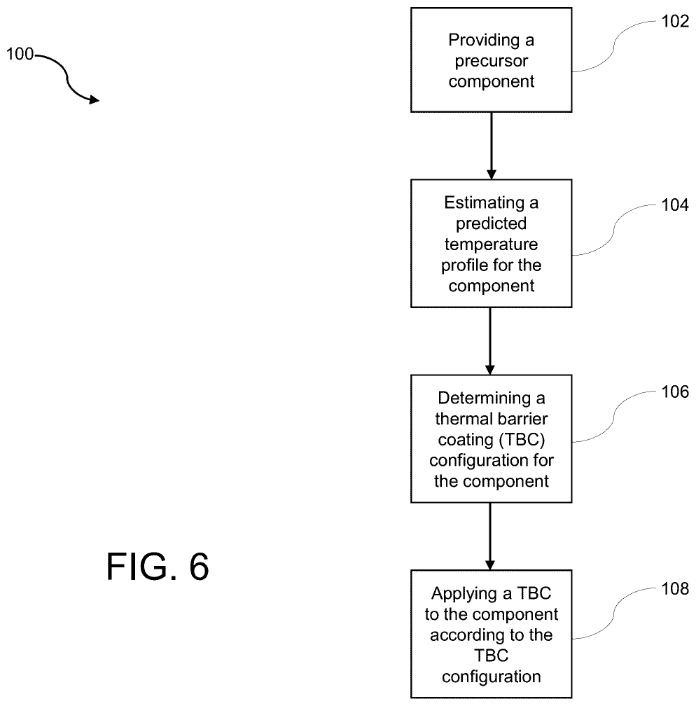

FIG. 6 is a flow diagram showing a method 100 of manufacturing a component of a gas turbine engine according to the present disclosure. In a first step 102, the method comprises providing a precursor component having at least one internal cooling passage configured to receive a flow of cooling air therethrough. In a second step 104, the method comprises estimating a predicted temperature profile for the component based on one or more operating parameters of the gas turbine engine, the predicted temperature profile indicating a predicted operating temperature of at least one gas-washed surface of the component. In a third step 106, the method comprises determining a thermal barrier coating (TBC) configuration for the component based on the predicted temperature profile, comprising setting a TBC thickness to be below a threshold thickness in a region of the at least one gas-washed surface of the component based on the predicted operating temperature of the at least one gas-washed surface of the component exceeding a threshold temperature. In a fourth step 108, the method comprises applying a TBC to the precursor component according to the TBC configuration.

The method of the present disclosure uses an approach for applying TBC to a component of a gas turbine engine which is in contrast to the conventional practice used. The conventional practice seeks to set a uniform TBC thickness across the component to ensure all gas-washed surfaces are equally protected against high temperatures. Some areas of the component which are at risk of experiencing particularly high temperatures may be given a thicker TBC to provide additional protection. The present approach seeks to reduce or eliminate TBC in gas-washed surfaces of the component which experience the highest temperatures. It has been surprisingly found that in some cases and locations of the component, the level of cooling airflow required to maintain the temperature of the component within safe operating limits is reduced for an un-coated surface of the component or a surface of the component with a relatively low TBC thickness which experiences high operating temperatures, as compared to the corresponding level of cooling airflow required for a surface with a relatively high TBC thickness which experiences high operating temperatures. By reducing the level of cooling airflow required, the efficiency of the gas turbine engine can be increased. The level of TBC thickness in each area of the component can therefore be optimised using the present method such that each of the metallic component, the bond coat, and the TBC can operate within safe operating temperatures, whilst minimising the cooling airflow required. This can reduce the chance of thermal or mechanical failure of the component, the bond coat, and/or the TBC during operation of the gas turbine engine. By using one or more masks to inhibit the coating material during a line-of-sight coating process, the TBC can be applied to the precursor component in a manner allowing the TBC thickness to be varied locally across the component. In a conventional approach, the geometry of the component is restricted by the level of TBC thickness which is required to be applied to the component. For example, this requirement limits the curvature of the component to a level which is needed to enable the required level of TBC thickness to adhere to the component. By applying reduced levels of TBC or eliminating TBC in certain areas of the component, the geometry of the component can be varied, presenting a greater level of design freedom. This can result in the component having more aerodynamically efficient geometry than would otherwise be possible. The system and method of the present disclosure therefore enables the optimum TBC configuration to be determined and subsequently applied to the precursor component.

It will be understood that the disclosure is not limited to the embodiments above-described and various modifications and improvements can be made without departing from the concepts described herein. Except where mutually exclusive, any of the features may be employed separately or in combination with any other features and the disclosure extends to and includes all combinations and sub-combinations of one or more features described herein.

What is claimed is:

1. A method of manufacturing a component of a gas turbine engine, comprising:
providing a precursor component having at least one internal cooling passage configured to receive a flow of cooling air therethrough;
estimating a predicted temperature profile for the component based on one or more operating parameters of the gas turbine engine, the predicted temperature profile indicating a predicted operating temperature of at least one gas-washed surface of the component;
determining a thermal barrier coating (TBC) configuration for the component based on the predicted temperature profile, comprising setting a TBC thickness to be below a threshold thickness in a region of the at least one gas-washed surface of the component based on the predicted operating temperature of the at least one gas-washed surface of the component exceeding a threshold temperature; and
applying a TBC to the precursor component according to the TBC configuration.

2. The method as claimed in claim 1, wherein the one or more operating parameters comprise at least one of a parameter relating to a temperature of operation of the gas turbine engine, a temperature of the component during operation of the gas turbine engine, an air pressure during operation of the gas turbine engine, a location of operation of the gas turbine engine, or a geometry of the component.

3. The method as claimed in claim 2, wherein the one or more operating parameters further comprises a cooling airflow capacity of the component defined by the at least one internal cooling passage.

4. The method as claimed in claim 1, wherein the at least one gas-washed surface of the component is formed by an external surface of the precursor component.

5. The method as claimed in claim 1, wherein estimating the predicted temperature profile further comprises:
estimating a predicted TBC thickness for the component based on an application of a baseline TBC level to the precursor component, wherein the at least one gas-washed surface is formed by the baseline TBC; and
determining the predicted operating temperature of the at least one gas-washed surface based on the one or more operating parameters of the gas turbine engine.

6. The method as claimed in claim 5, wherein determining the TBC configuration comprises adjusting a baseline TBC thickness as defined by the baseline TBC level.

7. The method as claimed in claim 1, wherein the threshold temperature is based on at least one of the operating conditions of the gas turbine engine, a type of the component, a geometry of the component, a material of the component, a material of the TBC, a material of a bond coat applied to the precursor component, or a cooling airflow capacity of the component.

8. The method as claimed in claim 1, wherein applying the TBC to the precursor component according to the TBC configuration comprises using a line-of-sight coating process.

9. The method as claimed in claim 8, wherein applying the TBC to the precursor component comprises using at least one mask positioned in a line-of-sight direction between a coating source and the precursor component to inhibit coating to an external surface of the precursor component.

10. The method as claimed in claim 8, wherein applying the TBC to the precursor component comprises applying a TBC having an intermediate thickness to the precursor component using the line-of-sight coating process to form an intermediate component; and
removing TBC material from the intermediate component to form a component having a TBC thickness according to the TBC configuration.

11. A system for manufacturing a component of a gas turbine engine, comprising:
a coating apparatus configured to apply a thermal barrier coating (TBC) to a precursor component, the precursor component at least one internal cooling passage configured to receive a flow of cooling air therethrough; and
processing circuitry coupled to the coating apparatus and configured to execute instructions comprising:
estimating a predicted temperature profile for the component based on one or more operating parameters of the gas turbine engine, the predicted temperature profile indicating a predicted operating temperature of at least one gas-washed surface of the component; and
determining a TBC configuration for the component based on the predicted temperature profile, comprising setting a TBC thickness to be below a threshold thickness in a region of the at least one gas-washed surface of the component based on the predicted operating temperature of the at least one gas-washed surface of the component exceeding a threshold temperature;
wherein the coating apparatus is configured to apply a TBC to the precursor component according to the TBC configuration.

12. The system as claimed in claim 11, wherein the one or more operating parameters comprise at least one of a parameter relating to a temperature of operation of the gas turbine engine, a temperature of the component during operation of the gas turbine engine, an air pressure during operation of the gas turbine engine, a location of operation of the gas turbine engine, or a geometry of the component.

13. The system as claimed in claim 12, wherein the one or more operating parameters further comprise a cooling airflow capacity of the component defined by the at least one internal cooling passage.

14. The system as claimed in claim 11, wherein the at least one gas-washed surface of the component is formed by an external surface of the precursor component.

15. The system as claimed in claim 11, wherein estimating the predicted temperature profile further comprises:
estimating a predicted TBC thickness for the component based on an application of a baseline TBC level to the precursor component, wherein the at least one gas-washed surface is formed by the baseline TBC; and
determining the predicted operating temperature of the at least one gas-washed surface based on the one or more operating parameters of the gas turbine engine.

16. The system as claimed in claim 15, wherein determining the TBC configuration comprises adjusting a baseline TBC thickness as defined by the baseline TBC level.

17. The system as claimed in claim 11, wherein the threshold temperature is based on at least one of the operating conditions of the gas turbine engine, a type of the component, a geometry of the component, a material of the component, a material of the TBC, a material of a bond coat applied to the precursor component, or a cooling airflow capacity of the component.

18. The system as claimed in claim 11, wherein the coating apparatus is a line-of-sight coating apparatus.

19. The system as claimed in claim 11, further comprising at least one mask configured to inhibit coating to the precursor component;
wherein applying the TBC to the precursor component comprises positioning the at least one mask in a line-of-sight direction between a coating source and the precursor component to inhibit coating to an external surface of the precursor component.

20. The system as claimed in claim 18, wherein applying the TBC to the precursor component comprises applying a TBC having an intermediate thickness to the precursor component using the line-of-sight coating apparatus to form an intermediate component; and
removing TBC material from the intermediate component to form a component having a TBC thickness according to the TBC configuration.
